(19) United States
(12) Patent Application Publication
(10) Pub. No.: US 2007/0041386 A1
(43) Pub. Date: Feb. 22, 2007

(54) Plug and play cluster deployment

(75) Inventors: David Bryan Mar, Austin, TX (US); Bharat Sajnani, Austin, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 11/205,650

(22) Filed: Aug. 17, 2005

(51) Int. Cl. H04L 12/56

(52) U.S. Cl. 370/395.52; 370/254; 709/223

(57) ABSTRACT

In a method of configuring a plurality of computer systems coupled through a network, each computer system comprises a bootable hard disk partition and the method comprises the steps of: automatically assigning an IP node address to each computer system coupled with the network; establishing a master node and creating a re-deployment image partition; synchronizing all computer systems which should receive the re-deployment image partition; broadcasting the re-deployment image partition from the master node; receiving the re-deployment image partition at each computer system; re-booting each computer system from their respective hard disk partition.

### FIELD OF THE INVENTION

The present invention relates to computer systems. More specifically, the present invention relates to a technique for installing and configuring one or more network clusters.

### BACKGROUND OF THE RELATED ART

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Deployment of large clusters of computers or servers is time consuming. In particular installation of Operating Systems (OS) and programs is mostly handled by pre-loading the respective programs or OS on the hard disk of a respective system. However, these programs or OS need to be installed before they can be executed or run on that specific system. Typically, a user has to step through the respective installation process which require the user to insert disks and/or CD-ROMs and then answer certain questions so that the installation program knows how to configure the respective program or OS. In case of a single system, this does not constitute a big burden and can be easily performed. However, in case of a large network or cluster, installing new software can take a lot of time. For example, a new network consisting of 50 computers requiring installation of complex software that typically takes 2 hours per installation would result in 100 hour installation time.

Another known method would be to create a primary server and then ship from this server data to each of the nodes. Thus, nodes would be installed in a serial and automatic fashion. However, even though automated, this still would require a significant amount of time if, for example, 100-200 nodes would be involved in such an upgrading or installation process. Network bandwidth becomes a problem, as each node downloading the image can be problematic. Furthermore, installing a new network requires so far the step of configuring the internet protocol (IP) settings onto each machine so that they are configured and assigned correctly for each new node. This is often a problem because IP addresses are network specific and consequently cannot be configured during the factory process by the manufacturer. Moreover, for clusters at remote sites, often the trained personnel must be deployed to configure each device, adding an additional expense including time and money for the consumer. This renders an automatic installation of a network practically impossible.

Finally, Enterprise Group Management has become a more important concern for the majority of distributed applications that are created for clusters. In the prior art, DHCP (which stands for Dynamic Host Control Protocol) servers, which use client server technology to deploy a node with an IP address. The disadvantage of DHCP is that the server must be set up and be operational before configuration of a cluster. In addition, DHCP is a general purpose algorithm and does not help in assisting configuration of a cluster of computers in a logical fashion. In addition, management of large clusters or computer grids is almost impossible using DHCP technology alone. There have been Auto IP draft protocols proposed in the past. However, the draft Auto IP proposals lack the knowledge of each node knowing about the other nodes. This prevents each other node from knowing which node should belong to the cluster and, therefore, which nodes are useful for solving cluster-related problems.

### SUMMARY OF THE INVENTION

The present invention is useful for those situations where new networks or clusters with a plurality of nodes/computer systems are to be installed and where nodes of a cluster are added or removed from the cluster itself, and also those situations where the new cluster needs to perform basic configuration tasks without outside direction or supervision.

Each node of the cluster may be fitted with an agent. The agent can be implemented in hardware, in software, or some combination of hardware and software. The agent may be used to perform basic cluster configuration activities upon startup and/or after a given time period has expired. The configuration activities can vary widely.

In a first exemplary method of configuring a plurality of computer systems coupled through a network, each computer system comprises a bootable hard disk partition and the method comprises the steps of: automatically assigning an IP node address to each computer system coupled with the network; establishing a master node and creating a re-deployment image partition; synchronizing all computer systems which should receive the re-deployment image partition; broadcasting the re-deployment image partition from the master node; receiving the re-deployment image partition at each computer system; re-booting each computer system from their respective hard disk partition.

The method can be executed between peer to peer computer systems, wherein each computer system installing a re-deployment image will serve as a new master node, and wherein the steps of synchronizing, broadcasting, receiving, and re-booting are repeated for nodes following the new master node. The step of automatically assigning an IP node may address comprise the steps of obtaining a set of network addresses; broadcasting a network address from the set of network address onto the network; determining if the network address has been assigned; and if the address has not been assigned, then assigning the address to the node. The method may further comprise the step providing a configuration list including parameters for each node. The configuration list can be preloaded on each computer system. The configuration list can be broadcasted to each computer system from the master node. The step of automatically assigning an IP node address may comprise the steps of listening by a node a ping from other nodes, the ping containing a network address; listening for responses to the ping; and if no response is received, then assigning the network address to another node in the cluster. The step of automatically assigning an IP node address may also comprise the steps of: detecting a ping, the ping containing the network address; determining if the network address is assigned to the node and, if so, responding to the ping; determining if the node issued the ping, and if not then listening for a response to the ping and if a response was not received then assigning the network address to another node in the cluster; if the node issued the ping and no response was received then assigning the network address to the node, otherwise selecting another network address and issuing another ping containing the another network address. The step of automatically assigning an IP node address may comprise the steps of: providing a pre-defined list of two or more network addresses; at a pre-defined event, selecting a first address from the list of network addresses; pinging the network with the first address; determining if a response was received after the ping; if no response was received after the ping, then assigning the first address to the node. The method may further comprise the step of :if the response was received, then selecting a next address from the list of network addresses. The method may also comprise the step of: pinging the network with the next address. The method may further comprise the step of, if no response was received after the ping, then assigning the next address to the node. The network may have two or more clusters.

In another exemplary method of configuring a computer system coupled through a network, wherein the computer system comprises a bootable hard disk partition, the method comprises the steps of:—automatically assigning an IP node address to the computer system;—determining whether a broadcast channel exists;—if a broadcast channel exists, then:—waiting for other computer systems coupled to the network to join a broadcast;—receiving a re-deployment image through the broadcast and storing the re-deployment image on the bootable hard disk partition;—re-booting the computer system from the hard disk partition;

The method may further comprise the steps of: if no broadcast channel exists then: creating a broadcast channel; installing a re-deployment image on the hard disk partition; adding subscribers to the broadcast channel; broadcasting the re-deployment image through the broadcast channel. Before creating a broadcast channel the method may further comprise the steps of: waiting a predetermined time; determining whether a broadcast channel exists; if a broadcast channel exists then: waiting for other computer systems coupled to the network to join a broadcast; receiving a re-deployment image through the broadcast and storing the re-deployment image on the bootable hard disk partition; and re-booting the computer system from the hard disk partition. The step of automatically assigning an IP node address may comprise the steps of: obtaining a set of network addresses; broadcasting a network address from the set of network address onto the network; determining if the network address has been assigned; and if the address has not been assigned, then assigning the address to the computer system. The method may further comprise the step of configuring the computer system according to a configuration list including parameters for the computer system. The configuration list can be preloaded on the computer system. The configuration list can be received through the broadcast. The step of automatically assigning an IP node address may comprise the steps of: detecting a ping, the ping containing the network address; determining if the network address is assigned to the computer system and, if so, responding to the ping; determining if the computer system issued the ping, and if not then listening for a response to the ping and if a response was not received then assigning the network address to another node in the cluster; and if the computer system issued the ping and no response was received then assigning the network address to the computer system, otherwise selecting another network address and issuing another ping containing the another network address. The step of automatically assigning an IP node address may comprise the steps of: providing a pre-defined list of two or more network addresses; at a pre-defined event, selecting a first address from the list of network addresses; pinging the network with the first address; determining if a response was received after the ping; if no response was received after the ping, then assigning the first address to the computer system. The method may further comprise the steps of: if the response was received, then selecting a next address from the list of network addresses; pinging the network with the next address; and if no response was received after the ping, then assigning the next address to the node.

An exemplary embodiment of an information handling system comprises two or more nodes, each of the nodes having a processor constructed and arranged to execute applications and a bootable partition, each of the nodes further operative with a network, each of the nodes further constructed and arranged to receive a ping containing a network address; and an agent on each of the nodes, the agent constructed and arranged to generate automatically an IP address and upon establishing the IP address to receive a re-deployment image which the agent stores on the bootable partition and wherein the agent reboots the node upon download of the re-deployment image.

The agent may generates a set of network addresses, the agent further may be constructed and arranged to determine if the pinged network address is assigned to another of the nodes or if the pinged network address is available for assignment to itself; wherein when the node receives a ping, the agent determines whether the network address is available by listening for a response to the ping; The two or more nodes can further be constructed and arranged to issue a ping containing the network address. The node can further be constructed and arranged to detect a response to the ping and, if no response is received, then the node assigns the network address to itself. One of the nodes can be a master node which stores the re-deployment image.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 depicts a computer system.

FIG. 2 depicts a computer cluster.

FIG. 3 depicts an agent used within a computer system of a node.

FIG. 4 is a flowchart illustrating a method according to the teachings of the present disclosure regarding.

FIG. 5 is a flowchart illustrating another method according to the teachings of the present disclosure regarding.

FIG. 6 is a flowchart illustrating a method for automatic IP assignment.

FIG. 7 is a flowchart illustrating another method for automatic IP assignment.

FIG. 8 is a flowchart illustrating yet another method for automatic IP assignment.

FIG. 9 shows an exemplary network with a plurality of nodes for use of one of the exemplary methods according to the invention.

The present disclosure may be susceptible to various modifications and alternative forms. Specific exemplary embodiments thereof are shown by way of example in the drawing and are described herein in detail. It should be understood, however, that the description set forth herein of specific embodiments is not intended to limit the present disclosure to the particular forms disclosed. Rather, all modifications, alternatives, and equivalents falling within the spirit and scope of the invention as defined by the appended claims are intended to be covered.

### DETAILED DESCRIPTION

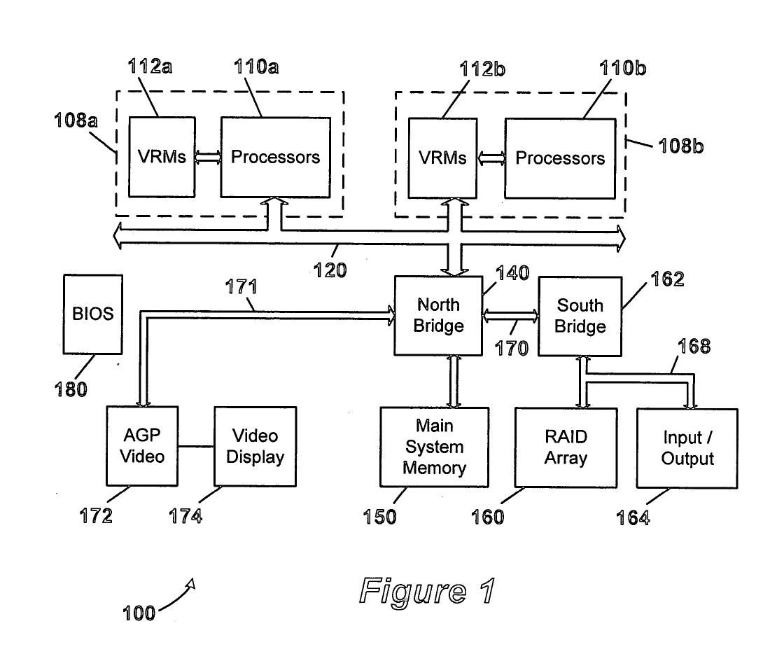

Elements of the present disclosure can be implemented on a computer system, as illustrated in FIG. 1. Referring to FIG. 1, depicted is an information handling system, generally referenced by the numeral 100, having electronic components mounted on at least one printed circuit board (“PCB”) (not shown) and communicating data and control signals there between over signal buses. In one embodiment, the information handling system may be a computer system. The information handling system may be composed processors 110 and associated voltage regulator modules (“VRMs”) 112 configured as processor nodes 108. There may be one or more processor nodes 108, one or more processors 110, and one or more VRMs 112, illustrated in FIG. 1 as nodes 108a and 108b, processors 110a and 110b and VRMs 112a and 112b, respectively. A north bridge 140, which may also be referred to as a “memory controller hub” or a “memory controller,” may be coupled to a main system memory 150. The north bridge 140 may be coupled to the processors 110 via the host bus 120. The north bridge 140 is generally considered an application specific chip set that provides connectivity to various buses, and integrates other system functions such as memory interface. For example, an INTEL® 820E and/or INTEL® 815E chip set, available from the Intel Corporation of Santa Clara, Calif., provides at least a portion of the north bridge 140. The chip set may also be packaged as an application specific integrated circuit (“ASIC”). The north bridge 140 typically includes functionality to couple the main system memory 150 to other devices within the information handling system 100. Thus, memory controller functions, such as main memory control functions, typically reside in the north bridge 140. In addition, the north bridge 140 provides bus control to handle transfers between the host bus 120 and a second bus(es), e.g., PCI bus 170 and AGP bus 171, the AGP bus 171 being coupled to the AGP video 172 and/or the video display 174. The second bus may also comprise other industry standard buses or proprietary buses, e.g., ISA, SCSI, USB buses 168 through a south bridge (bus interface) 162. These secondary buses 168 may have their own interfaces and controllers, e.g., RAID Array storage system 160 and input/output interface(s) 164. Finally, a BIOS 180 may be operative with the information handling system 100 as illustrated in FIG. 1. The information handling system 100 can be combined with other like systems to form larger systems. Moreover, the information handling system 100, can be combined with other elements, such as networking elements, to form even larger and more complex information handling systems.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory as described above. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

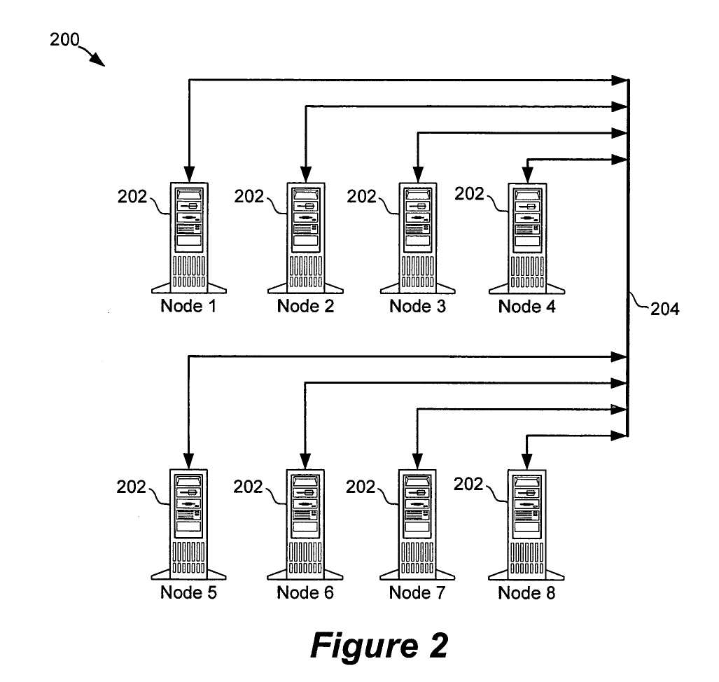

One of the more complex computer systems is a cluster of computers. FIG. 2 illustrates a cluster. The cluster 200 may be composed of two or more nodes 202 that can be, for example, a computer system 100 as described above. Each node 202 in the cluster may be operative with a network 204 as illustrated in FIG. 2. Typically, each node within the cluster 200 may be assigned a unique network address. The unique network address can be, for example, an Internet Protocol (“IP”) address, although other addressing schemes may be used with greater, equal, or lesser effect with the address assignment techniques disclosed herein.

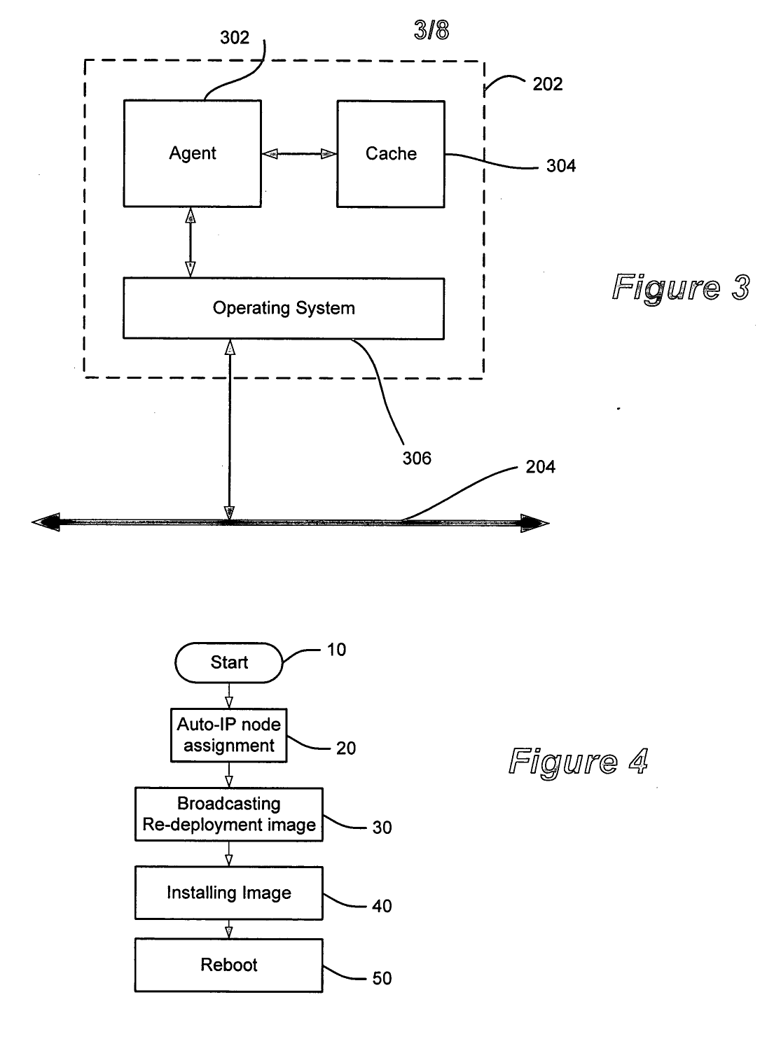

To ensure unique addressing and handling of the download of an executable program/OS (image) within the cluster, each node of the cluster can be fitted with an agent application. As illustrated in FIG. 3, the agent application 302 can be implemented in hardware on the computer system 100, or in software executing on one or more of the processors 110, or in any combination of hardware and software. FIG. 4 shows an exemplary method for performing a plug and play installation of a computer cluster. The process starts with step 10 and performs an auto IP node assignment in step 20. To this end, the agent 302, for example, merely needs to be able to cause the operating system 306 (or other system utility) to issue, for example, a ping on the network 204. Secondly, the agent needs to be able to reference a list or database of network addresses called the cache 304. The contents of the cache 304 can be located on and/or retrieved from another computer, be composed of a pre-defined list that may be placed on the node itself, or may be generated by the agent itself by an algorithm using pre-defined parameters or parameters obtained from a configuration file and/or from a server. Then in step 30, the agent needs to download the respective bootable image partition provided, for example, by one node. The bootable image partition can be created by a master node, for example, the first node which is activated. Alternatively, the image partition can be created externally, for example, by a system designed for configuring complex networks. Next in step 40, this image is installed, for example, on a partition of the hard disk of the computer system. Finally in step 50, the system needs to reboot. Because all nodes receive the image at the same time, parallel installation of all systems occurs, thus, saving a lot of installation time and costs. Such a method can be used for an initial setup of a cluster, for example a cluster with 50 computer systems (nodes). However, the method will also work for upgrading purposes during which either additional nodes are coupled to the system or/and new operating systems or complex programs are installed on the existing systems.

As described above, deploying enterprise clusters could be done completely from one node. Such a master node can be created during initial setup. For example, the first node that receives an IP address during the auto-IP node assignment will not detect any broadcast and could then simply create a master re-deployment image for all other nodes that will be added to the cluster. This solution uses the fact that after an auto IP node assignment, a master node will know about all other nodes and can then send its re-deployment image to all agents at the same time. The agent identifies that image and ensures that the destination is correct. Then it deploys the image onto itself and may send the configuration information back to the master node.

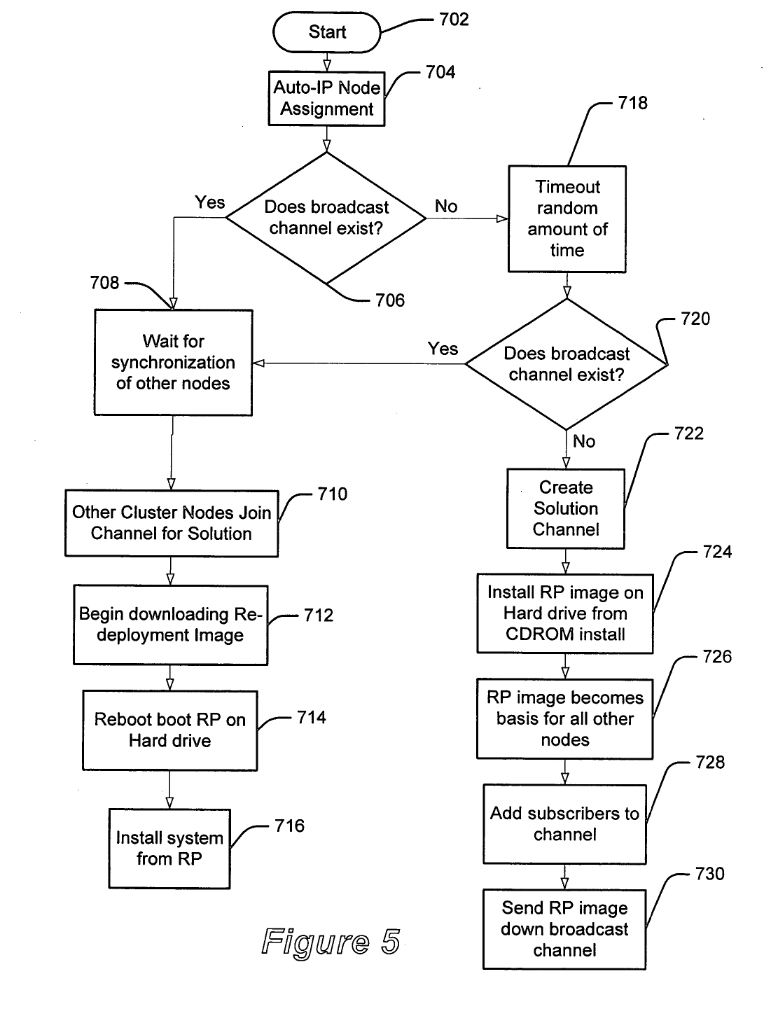

FIG. 5 shows another more detailed embodiment of a method according to the present application. The process starts with step 702. In step 704, again, an auto IP node assignment process is performed as will be explained in more detail later. Once an IP address has been automatically assigned, the agent checks whether a broadcast channel for this particular cluster exists in step 706. Different nodes of a cluster or within a cluster can be assigned to specific solution channels, such as, Oracle 9i, Oracle 10g, etc. If such a channel exists, then the agent waits for other nodes to synchronize the following broadcast in steps 708 and 710. As mentioned above, a specific solution can be assigned to specific nodes. Thus, these nodes subscribe to different broadcast channels. Once all systems subscribing to a broadcast channel have joined, which can be determined by either a certain timeout or by checking the subscription status according to a predetermined list, the actual broadcast will begin in step 712 and all subscribing nodes will download the respective re-deployment image. Furthermore, each node in a cluster may have an specifically assigned configuration. To this end, the master node can, for example, also transmit a specific configuration file or such a file could have been pre-loaded on the hard drive of each node. Such a general configuration file can include a description of the IP configuration settings of the master node as well as the nodes that exist in that cluster. The configuration file might also include the respective solution channel assigned to a respective node. Once this download has been completed, the subscribing systems will reboot from the respective downloaded re-deployment partition (RP) from their hard disk in step 714. If necessary during a first run of the new system, in step 716 the system can configure itself using the configuration file. As mentioned above, the configuration file could be already stored on each node or could be transmitted during step 712 together with the image.

In case no broadcast channel exists, the agent then backs off in step 718 and waits a random amount of time to repeat the test for an existing broadcast channel in step 720. If by now, such a broadcast channel exists, then the agent continues with step 708. However, if no such channel exists, then the agent creates a solution channel in step 722. To this end, the respective system installs a re-deployment partition (RP) image on its hard drive, for example, from a CDROM installation CD in step 724. This RP image then becomes the basis for all other nodes in step 726. In step 728, the system now adds subscribers to this newly created channel and broadcasts the respective newly created RP image in step 730 for all other subscribers.

The auto IP node installation process of steps 20 and 704 will now be explained in more detail. Once the hardware is set up and connected, the respective nodes that are connected with the network will initially perform either boot through a Pre-Boot Execution Environment (PXE)-boot, through a CDROM, or through a local hard drive. During this boot, the respective preliminary operating system 306, the agent 302 and if necessary the cache 304 are installed. For auto IP node addressing, in one embodiment, the agent 302 of a node 202 sends out an address resolution protocol (“ARP”) ping onto the network 204 that can be cached into the ARP cache 302. The ARP cache 302 can then be leveraged to assign network addresses for various nodes 202 within the cluster 200. In practice, an agent 302 can be operative on each node 202 and, upon booting of the respective node 202, each of those agents 302 performs a broadcast ping of a particular set of IP address to which the node 202 may be assigned. The agent 302 uses its ARP cache 304 to determine whether the pinged IP address has been taken. The ARP cache 302 is also useful because not all of the nodes 302 reside on the cluster's private network 204. Thus, the ARP cache 304 provides a way to ensure that a network address within the cluster 200 is not confused with a network address of a machine outside of the cluster 200. Use of the ARP cache 304 and agents 302 simplifies cluster management because a node 202 knows about the other nodes on its cluster only. While configuration of other nodes in a cluster could be configured from a master node, using the method of the present disclosure, each of these nodes can configure itself and know of the other nodes within the cluster without direction or intervention.

The contents of the ARP cache 304 can be generated or determined in many ways. In one embodiment, a configuration file may be provided to each agent 302 on the node 202 with a complete list of network addresses that are available for the cache 304. In another embodiment, the agent 302 may be provided with a configuration file (or may be preset to access a designated server) indicating where the node can retrieve the list of network addresses for the cache 304. In another embodiment, the configuration file has a beginning address and an end address, and the agent 302 then uses those parameters to generate any or all of the intermediate addresses using a generation algorithm or simply generate a complete sequential list which may be stored in the cache 304. In another embodiment, the cache 304 can be predefined in a configuration file that describes the IP configuration settings of a master node as well as the end nodes that exist in the cluster 200. Alternatively, the configuration file may designate a DHCP server from which the network address may be obtained.

While it may be contemplated that the node's agent would obtain a network address upon startup of the node, alternate embodiments may have the node assign or reassign its network address periodically after restart. For example, the network address may be reassigned daily, or weekly (or some other period of time) to account for fluctuations in the configuration of the cluster and/or the number of nodes within the cluster. Finally, the techniques presented in the present disclosure are useful because a user may deploy a cluster or grid from a single workstation without having to attach knowledge based management (“KBM”), Telnet or secure shell (“SSH”) onto each node once they have added the configuration file onto the master node or the central server.

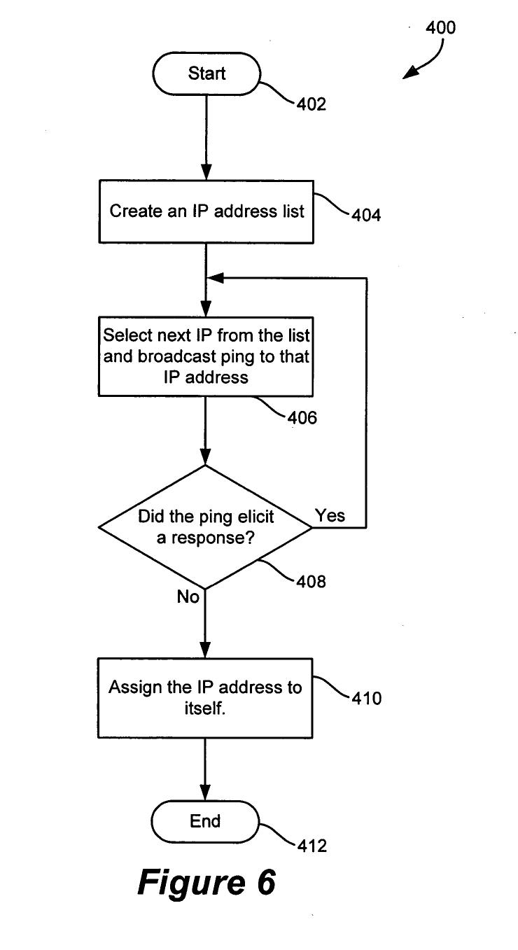

Another embodiment of the auto IP node assignment method is illustrated in FIG. 6. The method 400 starts generally at step 402. In step 404, the agent creates a list of network addresses (such as an Internet Protocol address). In step 406, the agent 302 selects one of the network addresses and issues a ping for that address onto the network connecting the cluster. In step 408, the node that issued the ping listens to the network to determine whether another node responded to the ping that it issued in step 406. If the issuing node received a response (i.e., the result of step 408 was “Yes”) then execution of the method 400 goes back to step 406 and a new network address may be tried. In one embodiment, the next address is simply the next one in a list, e.g., the index of the list may be incremented so that the next sequential address is tried. The increment can be one (i.e., the next address in the list) or the increment can be greater than one (to skip through the list more quickly). In another embodiment, the next address may be chosen randomly. Other embodiments may employ other mechanisms or techniques for determining the next address to try. Steps 406 and 408 continue until the ping does not elicit a response (i.e., the result of step 408 is “No”). Once there has been no response to the broadcast ping, then the node that broadcasts the ping, the address may be deemed available and the node that issued the ping assigns that network address to itself in step 410, and the method ends generally at step 412. As mentioned before, this process can be performed by each particular node. In one of the embodiments of the present invention, each node is only concerned with getting its own IP address from within the cluster system and knowing which other cluster nodes has which IP address may be not a concern.

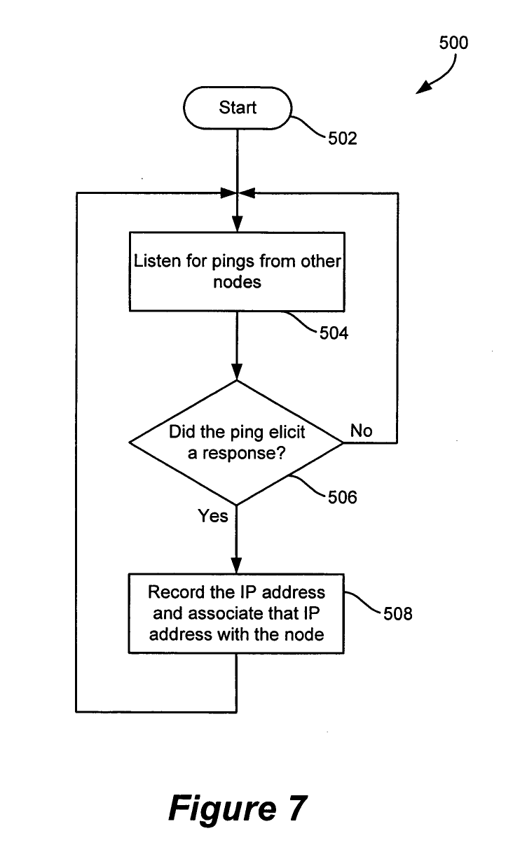

An additional auto IP node assignment method 500 is illustrated in FIG. 7. The method 500 can augment the method 400 in that the addresses of other nodes on the cluster can be recorded during the pinging process. In other words, according to method 500, each node 202 can retain information about the other nodes 202 on the cluster 200 so that those particular nodes or any particular node would know how many other nodes are available on the cluster. Such knowledge by each node 202 can be useful, for example, for different purposes such as load balancing, file sharing, failover, disaster recover, and the like. Referring to FIG. 5, the method 500 starts generally at step 502, followed by step 504, where the node 202 listens for pings issued by other nodes. In step 506, if a ping is detected by the node, it also listens for a response to that ping. If no node responded to the ping (i.e., the result of step 506 is “No”) then execution of the method 500 goes back to step 504. If a node did respond to the ping (i.e., the result of step 506 is “Yes”) then in step 508 the network address may be associated with a node on the cluster before execution may be looped back to step 504.

In yet a different auto IP node assignment method during the process of broadcast pinging and determining whether ping responses are made, each node will listen to any other node through its process of ping and response, and each of the nodes will then determine and listen for one node putting out a broadcast ping and then also listen onto the network of any responses that are made with the implicit assumption being that if a particular node sends out a ping request that is not responded to, then that particular node will then assign itself that IP address. Consequently, even though each individual node may only go partially through the set of addresses to obtain its own address, the node will be able to go through and correspond other nodes with other IP addresses because that node will have recorded the addresses of the other nodes. This latter embodiment may be useful for those situations where any particular node on the cluster may be called upon to act as the central node of knowing which network addresses are available within the cluster. Alternatively, any one of the nodes will be in a position to load in the requisite network configuration/address information to other nodes that are attached to the cluster. The list of network addresses can be of any length. Similarly, the incremental value, or the mechanism for choosing addresses may not be particularly important. However, it may be preferable to set as the list the complete subclass of the network.

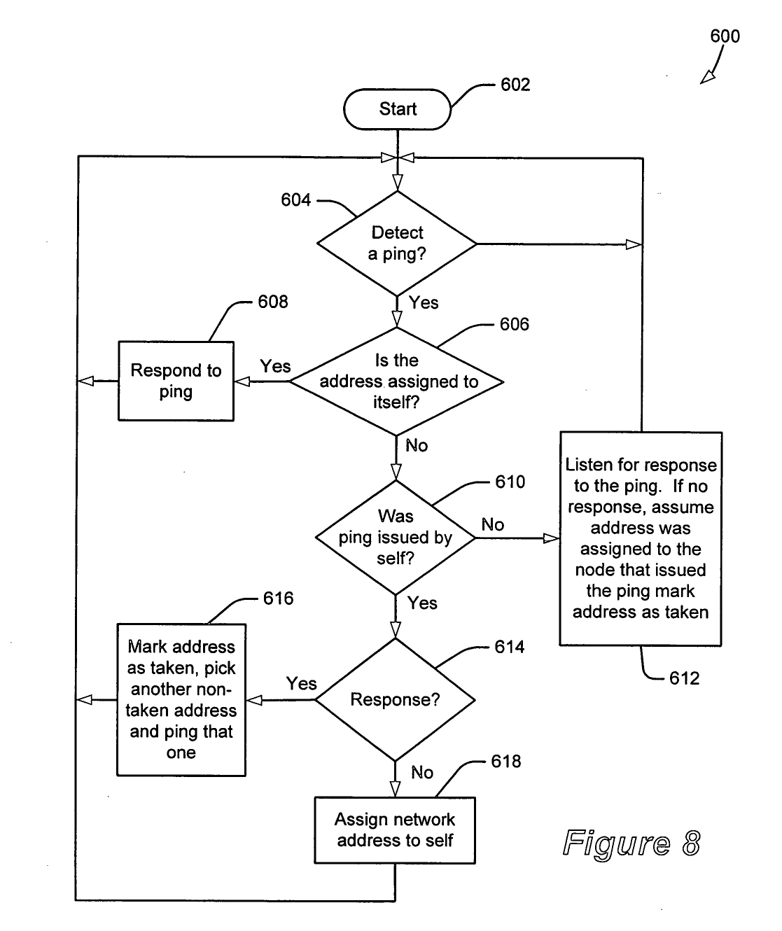

The previous embodiment is illustrated in FIG. 8, which depicts the method 600 beginning generally at step 602. In step 604, the node (via, for example, the agent 302) determines whether it detected a ping on the network. If not, step 604 may be repeated until a ping is detected (i.e., the result of step 604 is “Yes”). In step 606, the node will determine if the address in the ping is its own network address. If so, then in step 608, the node will respond to the ping and execution moves back to step 604. Otherwise, in step 610, the node determines whether the ping was issued by itself. If not, then in step 612, the node listens for a response to the ping. If no response was detected, then the node assumes that the other node that issued the ping assigned that address to that other node. The node can then record/indicate that address as taken by the other node within the cluster and execution moves back to step 604 as illustrated in FIG. 6. If the ping was issued by the node (i.e., the result of step 610 was “Yes”), then in step 614, the node determines whether or not a response to the ping was received. If a response to the ping was received (i.e., the result of step 614 was “Yes”) then in step 616, the ping address may be associated with a node on the cluster and another address may be generated/selected as the new address and the new address may then pinged onto the network and execution loops back to step 604. If there was no response to the ping (i.e., the result of step 614 was “No”) then step 618 can be executed, wherein the node assigns the network address as its own and execution loops back to step 604. It will be understood that the order of steps depicted in the previous methods 400, 500, and 600 can be changed with little or no effect on the results obtained and that a strict adherence to the order of the steps described may be unnecessary.

In another embodiment of such an auto IP node assignment, a central server performs the network assignment operation, using a protocol such as DHCP. In this embodiment, if there is a failover of the central node, the agents 302 of the various nodes 202 are activated and instructed to obtain network addresses via the methods outlined above. The nodes 202 can start from a predefined list if network addresses, or it may start from scratch, essentially invalidating any list that they has and re-running the agents so that network addresses can be reassigned to an individual nodes. Alternatively, one of the remaining nodes in the cluster can be designated as the new “master node” and the list of valid network addresses can be used to operate the cluster and/or update new nodes that are connected to the cluster. This method may be particularly useful for situations where one or more of the nodes suddenly become inoperative or the cluster's configuration has been changed significantly.

In an alternate embodiment of such an auto IP node assignment, each node of the cluster can determine a set of network addresses based upon a time-based algorithm. This embodiment may be useful for situations where elements of the cluster are allocated. at different parts of the day (perhaps on a periodic basis). For example, secretarial and office workstations may be added routinely at the end of the day. In that case, the workstation would become a new node on the cluster, and, with the agent 302, could obtain a network address on the cluster which would coincidentally make itself known to the cluster's workflow/task administrator.

In an alternate embodiment of such an auto IP node assignment, because the network address entries of the various nodes are known, the list of known addresses can be transferred to other nodes that are coming online so that those addresses may be safely skipped and only network addresses with a high-potential for availability will be pinged onto the network. Similarly, the network address entries of each of the nodes, instead of being completely wiped out, can be instead re-pinged by a single node (with the others listening) to determine whether the entry may be available. This would eliminate much of the ARP ping traffic associated with other embodiments.

In another embodiment of such an auto IP node assignment, each node of the cluster has a “network address” list, such as a list of IP addresses. In contrast to the other embodiments discussed above, the IP list of this embodiment can be limited to the cluster in question. This embodiment is useful because multiple clusters can be created on the same network (perhaps on a pre-defined or dynamic fashion) without interfering with each other. In this way, a network having hundreds or thousands of nodes (or more) can be subdivided into selected clusters for particular activities. Having a specific list of cluster-related nodes simplifies configuration because each node, or each cluster, need not know (or care) about the other nodes on the network. All that each cluster (and hence the node of that cluster) needs to know about is whether the network address is capable of becoming a member of the cluster. This embodiment enables several different activities. For example, a cluster can be created for a period of time, such as when all the secretaries leave the office for the day. The agents running on each of the secretaries workstations would note the beginning of the cluster time period, and initiate the pinging exercise to determine which of the nodes is available for that particular cluster. After a given time period, for example 10 minutes after the beginning of the cluster's designated time period, polling for entry into the cluster could be closed and the cluster's computational activities commenced. At a later time, for example an hour later, a new list of network addresses would be allowed for the organization of another cluster, with spare nodes (having the correct network address list) starting the pinging process to join the new cluster. In this way, spare computational capacity could be joined into one or more clusters on a periodic (or dynamic) basis. Similarly, this embodiment enables a single network to handle the organization and initiation of multiple clusters simultaneously (or in any particular sequence).

Referring to the previous embodiment of such an auto IP node assignment, three nodes could be pre-programmed with a set of IP addresses that need to be joined into a cluster (e.g., “cluster_1”) having the range of IP addresses of 1.1.1.4, 1.1.1.5, and 1.1.1.6, and upon invocation of the cluster, one or more nodes would ping/test that IP range. Similarly, a second cluster (e.g., “cluster_2”) could be pre-programmed to join the cluster and test a second set of IP addresses, such as 2.2.2.1, 2.2.2.2, 2.2.2.3, etc. Thus, even though the nodes of both clusters may be on the same network, the various nodes can coordinate among themselves without either of the clusters interfering with each other. This embodiment can be applied to two or more clusters. The only requirement is that the sets of network addresses do not overlap.

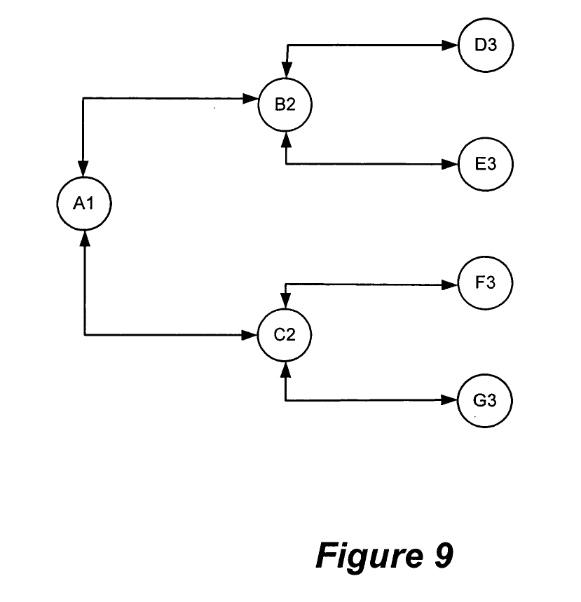

FIG. 9 shows another exemplary embodiment of the present invention. An exemplary network comprises a plurality of nodes A1, B2, C2, D3, E3, F3, and G3. FIG. 9 is used to explain the hierarchy in a deployment scheme according to the present invention. Each node comprises usually a computer system as explained above. Initially, node A1 is installed with a deployment image. Node A1 then, copies a deployment image of itself from the respective hard disk partition to peer-to-peer nodes B2 and C2. The nodes B2 and C2 then each install the received deployment image on their respective hard disk partitions. Then, nodes B2 and C2 will become master nodes, respectively and these newly installed deployment images will serve as a basis for the following nodes D3, E3 and F3, G3, respectively. Thus, each node copies itself to another peer-to-peer node. Thus, every time a node receives an deployment image, the node will install this image and create, thus, a new master deployment image for nodes that follow from that node, in other words, for nodes that are lower in the network hierarchy. Hence, once a primary node has been installed, installation of the nodes lower in hierarchy will automatically spawn through the remaining network which can be quite complex.

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A method of configuring a plurality of computer systems coupled through a network, wherein each computer system comprises a bootable hard disk partition, the method comprising the steps of:
automatically assigning an IP node address to each computer system coupled with the network;
establishing a master node and creating a re-deployment image partition;
synchronizing all computer systems which should receive said re-deployment image partition;
broadcasting said re-deployment image partition from said master node;
receiving said re-deployment image partition at each computer system;
re-booting each computer system from their respective hard disk partition.

2. A method according to claim 1, wherein the method is executed between peer to peer computer systems, wherein each computer system installing a re-deployment image will serve as a new master node, and wherein the steps of synchronizing, broadcasting, receiving, and re-booting are repeated for nodes following said new master node.

3. A method according to claim 1, wherein the step of automatically assigning an IP node address comprises the steps of:
obtaining a set of network addresses;
broadcasting a network address from the set of network address onto the network;
determining if the network address has been assigned; and
if the address has not been assigned, then assigning the address to the node.

4. A method according to claim 1, further comprising the step providing a configuration list including parameters for each node.

5. A method according to claim 4, wherein configuration list is preloaded on each computer system.

6. A method according to claim 4, wherein configuration list broadcasted to each computer system from said master node.

7. A method according to claim 1, wherein the step of automatically assigning an IP node address comprises the steps of:
listening by a node a ping from other nodes, the ping containing a network address;
listening for responses to the ping; and
if no response is received, then assigning the network address to another node in the cluster.

8. A method according to claim 1, wherein the step of automatically assigning an IP node address comprises the steps of:
detecting a ping, the ping containing the network address;
determining if the network address is assigned to the node and, if so, responding to the ping;
determining if the node issued the ping, and if not then listening for a response to the ping and if a response was not received then assigning the network address to another node in the cluster;
if the node issued the ping and no response was received then assigning the network address to the node, otherwise selecting another network address and issuing another ping containing the another network address.

9. A method according to claim 1, wherein the step of automatically assigning an IP node address comprises the steps of:
providing a pre-defined list of two or more network addresses;
at a pre-defined event, selecting a first address from the list of network addresses;
pinging the network with the first address;
determining if a response was received after the ping;
if no response was received after the ping, then assigning the first address to the node.

10. A method according to claim 9, further comprising:
if the response was received, then selecting a next address from the list of network addresses.

11. A method according to claim 10, further comprising:
pinging the network with the next address.

12. A method according to claim 11, further comprising:
if no response was received after the ping, then assigning the next address to the node.

13. A method according to claim 1, wherein the network has two or more clusters.

14. A method of configuring a computer system coupled through a network, wherein said computer system comprises a bootable hard disk partition, the method comprising the steps of:
automatically assigning an IP node address to said computer system;
determining whether a broadcast channel exists;
if a broadcast channel exists, then:
waiting for other computer systems coupled to said network to join a broadcast;
receiving a re-deployment image through said broadcast and storing said re-deployment image on said bootable hard disk partition;
re-booting said computer system from said hard disk partition;

15. A method according to claim 14, further comprising the steps of:
if no broadcast channel exists then:
creating a broadcast channel;
installing a re-deployment image on said hard disk partition;
adding subscribers to said broadcast channel;
broadcasting said re-deployment image through said broadcast channel.

16. A method according to claim 15, before creating a broadcast channel further comprising the steps of:
waiting a predetermined time;
determining whether a broadcast channel exists;
if a broadcast channel exists then:
waiting for other computer systems coupled to said network to join a broadcast;
receiving a re-deployment image through said broadcast and storing said re-deployment image on said bootable hard disk partition;
re-booting said computer system from said hard disk partition.

17. A method according to claim 14, wherein the step of automatically assigning an IP node address comprises the steps of:
obtaining a set of network addresses;
broadcasting a network address from the set of network address onto the network;
determining if the network address has been assigned; and
if the address has not been assigned, then assigning the address to the computer system.

18. A method according to claim 14, further comprising the step configuring said computer system according to a configuration list including parameters for said computer system.

19. A method according to claim 18, wherein said configuration list is preloaded on said computer system.

20. A method according to claim 18, wherein said configuration list is received through said broadcast.

21. A method according to claim 14, wherein the step of automatically assigning an IP node address comprises the steps of:
detecting a ping, the ping containing the network address;
determining if the network address is assigned to said computer system and, if so, responding to the ping;
determining if the computer system issued the ping, and if not then listening for a response to the ping and if a response was not received then assigning the network address to another node in the cluster;
if the computer system issued the ping and no response was received then assigning the network address to the computer system, otherwise selecting another network address and issuing another ping containing the another network address.

22. A method according to claim 14, wherein the step of automatically assigning an IP node address comprises the steps of:
providing a pre-defined list of two or more network addresses;
at a pre-defined event, selecting a first address from the list of network addresses;
pinging the network with the first address;
determining if a response was received after the ping;
if no response was received after the ping, then assigning the first address to the computer system.

23. A method according to claim 22, further comprising:
if the response was received, then selecting a next address from the list of network addresses;
pinging the network with the next address;
if no response was received after the ping, then assigning the next address to the node.

24. An information handling system comprising:
two or more nodes, each of the nodes having a processor constructed and arranged to execute applications and a bootable partition, each of the nodes further operative with a network, each of the nodes further constructed and arranged to receive a ping containing a network address; and
an agent on each of the nodes, the agent constructed and arranged to generate automatically an IP address and upon establishing said IP address to receive a re-deployment image which the agent stores on said bootable partition and wherein the agent reboots the node upon download of said re-deployment image.

25. An information handling system according to claim 24, wherein the agent generates a set of network addresses, the agent further constructed and arranged to determine if the pinged network address is assigned to another of the nodes or if the pinged network address is available for assignment to itself;
wherein when the node receives a ping, the agent determines whether the network address is available by listening for a response to the ping;

26. An information handling system according to claim 24, wherein the two or more nodes are further constructed and arranged to issue a ping containing the network address.

27. An information handling system according to claim 26, wherein the node is further constructed and arranged to detect a response to the ping and, if no response is received, then the node assigns the network address to itself.

28. An information handling system according to claim 24, wherein one of said nodes is a master node which stores said re-deployment image.
